(19) United States
(12) Patent Application Publication
(10) Pub. No.: US 2009/0038121 A1
(43) Pub. Date: Feb. 12, 2009

(54) AUXILIARY HANDLE DEVICE

(76) Inventors: Roswitha Eicher, Filderstadt (DE); Stefan Heess, Leinfelden-Echterdingen (DE); Joerg Maute, Sindelfingen (DE); Florian Esenwein, Uhingen-Holzhausen (DE); Bernhard Eicher, Filderstadt (DE); Marcus Schuller, Dettenhausen (DE)

Correspondence Address: Striker, Striker & Stenby, 103 East Neck Road, Huntington, NY, 11743, US

(21) Appl. No.: 12/168,292

(22) Filed: Jul. 7, 2008

(30) Foreign Application Priority Data
Aug. 6, 2007 (DE) 10 2007 037 043.3

(51) Int. Cl. B25G 1/01; B25D 17/04; B25F 5/02

(52) U.S. Cl. 16/426; 173/162.2; 16/431; 310/326

(57) ABSTRACT

An auxiliary handle device, in particular for a hand-held power tool, has an auxiliary handle and a damping unit that includes at least one damping element. The damping element is designed to pivot about a pivot axis while vibrations are being damped.

### CROSS-REFERENCE TO A RELATED APPLICATION

The invention described and claimed hereinbelow is also described in German Patent Application DE 10 2007 037 043.3 filed on Aug. 6, 2007. This German Patent Application, subject matter of which is incorporated herein by reference, provides the basis for a claim of priority of invention under 35 U.S.C. 119(a)-(d).

### BACKGROUND OF THE INVENTION

The present invention is directed to an auxiliary handle device.

An auxiliary handle device for a hand-held power tool with an auxiliary handle and a damping unit is already known. The damping unit includes a damping element that serves to dampen vibrations.

### SUMMARY OF THE INVENTION

The present invention is directed to an auxiliary handle device, in particular for a hand-held power tool, with an auxiliary handle and a damping unit that includes at least one damping element. It is provided in accordance with the invention that the damping element is designed to pivot about a pivot axis while vibrations are being damped.

In this context, an “auxiliary handle” is understood to be a region and/or a component and/or an element provided for placement—and enclosing, in particular—by one or two hands of an operator for guiding a hand-held power tool using an auxiliary handle device, and which is capable of being attached to the hand-held power tool in an auxiliary manner, adjacent to a further handle, in particular the main handle, the auxiliary handle device being located on the side of the hand-held power tool, and/or being capable of being removed from the hand-held power tool by an operator without the use of tools, and/or being located in a front region of the hand-held power tool close to the tool, and/or the auxiliary handle is designed in the shape of a rod. “Provided” is intended to mean, in particular, specially equipped and/or designed.

The inventive design provides an advantageous damping of the auxiliary handle—of the gripping region in particular—and, therefore, a high level of operating comfort for an operator. During operation of the hand-held power tool, oscillations and/or vibrations are preferably absorbed by the damping element via conversion of oscillation energy into energy of motion of the damping element. The inventive auxiliary handle device is basically usable in conjunction with all hand-held power tools that appear reasonable to one skilled in the technical art, thereby making it easier, in particular, for an operator to guide hand-held power tools using the auxiliary handle. Due to its damping property, the auxiliary handle device is particularly advantageous when used with an angle grinder.

To this end, the damping unit advantageously includes at least one bearing element, which is provided to support the damping element, thereby making it possible to attain a pivot motion of the damping element with the least amount of friction possible.

It is also provided that the damping element is designed as an absorber mass element, thereby making it possible to attain additional vibration damping by generating a counter-oscillation or a counter-vibration that offsets an initial oscillation of the hand-held power tool. In this context, an “absorber mass element” refers, in particular, to an element that is excited—at least within one intended frequency range of an initial oscillation and/or excitation oscillation—to generate a counter-oscillation and/or a counter-motion that offsets the initial oscillation, thereby contributing to a reduction of vibrations.

A particularly advantageous counter-oscillation may be attained when the absorber mass element is designed as an unbalanced mass. An “unbalanced mass” refers, in particular, to an element and/or a component that preferably has an asymmetrical distribution of mass relative to a pivot axis around which the element and/or component may rotate, thereby enabling an imbalance to be produced. The unbalanced mass may be designed, e.g., as a segment or circular in shape.

In a further embodiment of the present invention, it is provided that the damping unit includes at least one energy conversion element, which is provided in order to convert oscillation energy into electric energy.

The electric energy may be used, advantageously, to provide additional vibration damping, and/or for further applications that appear reasonable to one skilled in the technical art. This may be attained using a particularly simple design when the damping element includes at least a portion of the energy conversion element.

The auxiliary handle device preferably includes at least one end region of the auxiliary handle that extends in an axial direction, on which at least a portion of the damping element is located, thereby resulting in a space-saving design of the auxiliary handle device. An “axial direction” of the auxiliary handle refers to a direction of the auxiliary handle that is preferably oriented along a length of the auxiliary handle. In addition, an “end region” refers, in particular, to a region of the auxiliary handle that is located along the axial direction in a region facing an end of the auxiliary handle, and that extends along the axial direction by preferably up to 20% and particularly advantageously by up to 10% of a longitudinal extension of the auxiliary handle.

The auxiliary handle device preferably includes a fastening unit that is provided for attachment to the hand-held power tool, with at least a portion of the damping unit being located downstream of the end region that faces the fastening unit, in the direction of the fastening unit. As a result, the damping unit may be advantageously located inside the auxiliary handle device upstream of a grip region of the auxiliary handle, and at least partially along a vibration-transmission path of the hand-held power tool, via the fastening unit on the auxiliary handle.

When the damping unit includes at least two damping elements that are movable relative to each other, it is possible to attain an advantageous vibration damping that is preferably oriented in different directions and/or that is adapted to a different oscillation behavior of the hand-held power tool. The at least two damping elements are advantageously located such that they are movable—pivotable, in particular—along two different trajectories. As an alternative or in addition thereto, the at least two damping elements that pivot around different pivot axes are located, in particular, such that they are tiltable relative to each other.

Further advantages result from the description of the drawing, below. Exemplary embodiments of the present invention are shown in the drawing. The drawing, the description, and the claims contain numerous features in combination. One skilled in the art will also advantageously consider the features individually and combine them to form further reasonable combinations.

### BRIEF DESCRIPTION OF THE DRAWINGS

FIG. 1 shows a hand-held power tool with an inventive auxiliary handle device, in a schematic depiction,

FIG. 2 shows the auxiliary handle device with a damping element designed as an unbalanced mass, in a perspective view,

FIGS. 3a and 3b show the auxiliary handle device with several spherical damping elements supported in rings, in a perspective view, and

FIGS. 4a and 4b show the auxiliary handle device with several damping elements designed as rings, in a perspective view,

### DESCRIPTION OF THE PREFERRED EMBODIMENTS

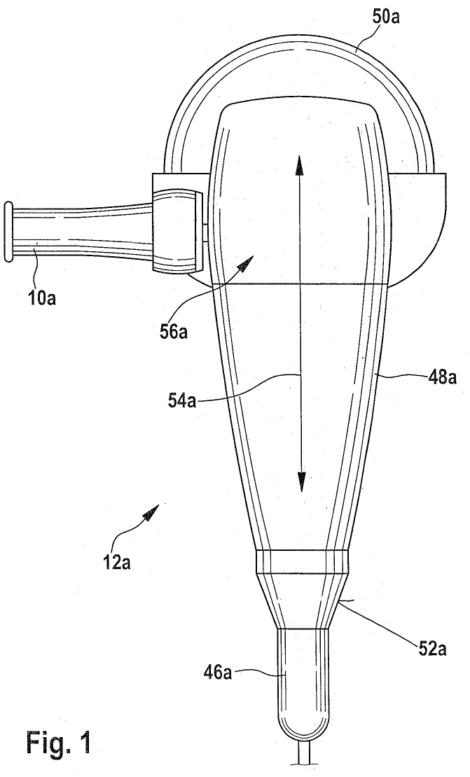

A hand-held power tool 12a designed as an angle grinder is shown in FIG. 1, in a perspective view from above. The angle grinder includes a housing 48a and a main handle 46a integrated in housing 48a. Main handle 46a extends along a side 52a facing away from a tool 50a that is a cutting disk, in a longitudinal direction 54a of the angle grinder. An auxiliary handle device 10a is located in a front region 56a of the angle grinder that is close to the tool, and extends transversely to longitudinal direction 54a of the angle grinder.

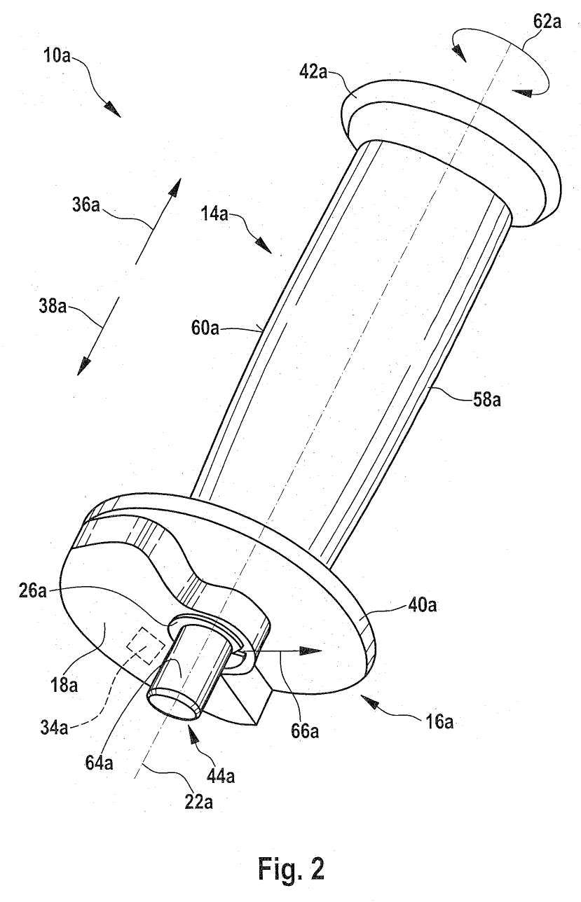

FIG. 2 shows auxiliary handle device 10a with an auxiliary handle 14a, a fastening unit 44a, and a damping unit 16a. Additional handle 14a includes a grip sleeve 58a, which extends along an axial direction 36a, 38a of auxiliary handle device 10a. Grip sleeve 58a also has a surface 60a that is curved radially outwardly in axial direction 36a, 38a of auxiliary handle 14a, thereby providing a particulary good grip for an operator of auxiliary handle device 10a. A ridge-type raised area is provided in axial direction 36a, 38a in end regions 40a, 42a of grip sleeve 58a, which serves to limit a gripping region of grip sleeve 58a for an operator. The two ridge-type raised areas are located on auxiliary handle 14a in the manner of rings that extend in a circumferential direction 62a, which is perpendicular to axial direction 36a, 38a. The two ridge-type raised areas extend radially outwardly from auxiliary handle 14a.

During operation of auxiliary handle device 10a, ridge-type raised areas prevent the operator's hand from slipping when the operator guides hand-held power tool 12a using auxiliary handle device 10a and/or while force is being transmitted by the operator via auxiliary handle device 10a to hand-held power tool 12a. Fastening unit 44a, which is designed to be screwed together with hand-held power tool 12a, includes a bolt-shaped fastening element 64a designed as a screw element that is non-rotatably mounted on end region 40a of auxiliary handle 14a in axial direction 38a via a bonded, non-positive, and/or form-fit connection.

Damping unit 16a of auxiliary handle device 10a is located in axial direction 38a, in the direction of fastening unit 44a, after end region 40a of auxiliary handle 14a that faces fastening unit 44a. Damping unit 16a includes a damping element 18a designed as an absorber mass element. Damping unit 16a absorbs oscillations and/or vibrations that are transmitted from hand-held power tool 12a to auxiliary handle device 10a by converting the oscillation energy into energy of motion of damping element 18a, which pivots around a pivot axis 22a. Pivot axis 22a is oriented parallel to axial direction 36a, 38a and extends in radial direction 66a through a center of auxiliary handle 14a. In addition, damping element 18a is designed as a disk-shaped, segment-like unbalanced mass for generating an imbalance and/or pivot motion. Damping element 18a extends around a circular segment of approximately 180°. Further designs of damping element 18a that generate an imbalance are also basically feasible.

For support, damping unit 16a includes a bearing element 26a that is located in circumferential direction 62a directly around fastening element 64a of fastening unit 44a and, in radial direction 66a, between fastening element 64a and the unbalanced mass. In addition, bearing element 26a is designed as a retaining element that limits a maximum fastening region of fastening element 64a in axial direction 36a, 38a, thereby allowing damping element 18a to pivot around pivot axis 22a when auxiliary handle device 10a is installed on hand-held power tool 12a. During operation, the unbalanced mass is excited by an initial oscillation of a hand-held power tool 12a to oscillate and/or pivot around pivot axis 22a, the pivoting motion of the unbalanced mass offsetting the initial oscillation.

Damping element 16a and/or damping element 18a also include(s) an energy conversion element 34a that is provided to convert the oscillation energy into electric energy during operation of hand-held power tool 12a and/or auxiliary handle device 10a. Energy conversion element 34a may be designed as a piezoelectric element, a type of generator, and/or other energy conversion elements 34a that appears reasonable to one skilled in the technical art. In a further embodiment of the present invention, it is also feasible for the unbalanced mass to be set into rotation via a drive unit.

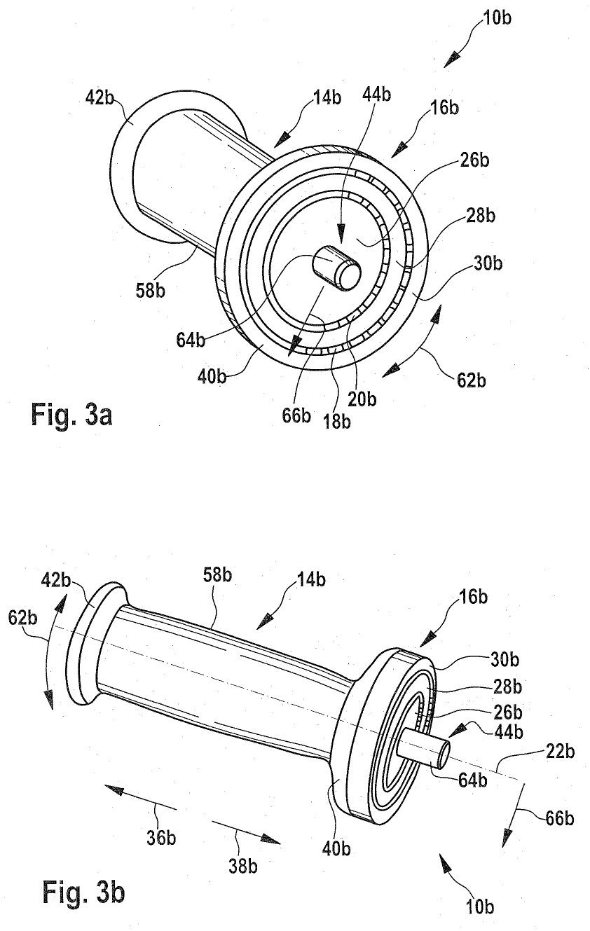

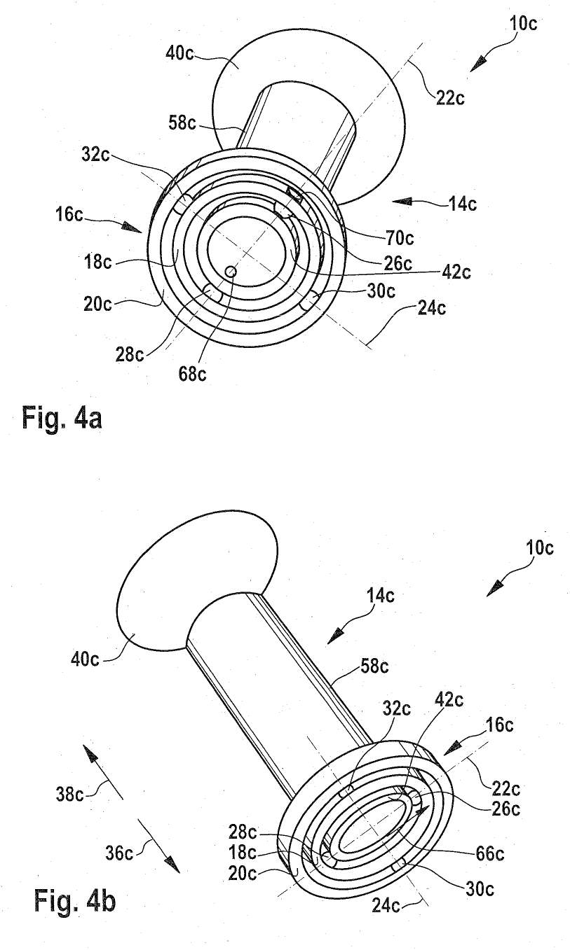

Alternative exemplary embodiments are shown in FIGS. 3a, 3b, 4a, and 4b. Components, features, and functions that are essentially the same are labelled with the same reference numerals. To distinguish the exemplary embodiments from each other, the reference numerals of the exemplary embodiments are appended with the letters a through c. The description below is essentially limited to the differences from the exemplary embodiment in FIGS. 1 and 2. With regard for the components, features, and functions that remain the same, reference is made to the description of the exemplary embodiment in FIGS. 1 and 2.

FIGS. 3a and 3b show an alternative auxiliary handle device 10b with a damping unit 16b that includes several spherical damping elements 18b, 20b, which are movable relative to each other. Damping elements 18b, 20b are designed as absorber mass elements that are located along an axial direction 38b that faces a fastening unit 44b, downstream of an end region 40b of an auxiliary handle 14b facing fastening unit 44b. To support damping elements 18b, 20b, damping unit 16b includes three bearing elements 26b, 28b, 30b, which are annular or disk-shaped in design, and which are provided with guide grooves extending in circumferential direction 62b for guiding damping elements 18b, 20b, the guide grooves extending in radial direction 66b in end regions of bearing elements 26b, 28b, 30b.

In addition, bearing elements 26b, 28b, 30b are located one after the other in radial direction 66b, with an innermost—in radial direction 66b—bearing element 26b being located in circumferential direction 62b directly around a fastening element 64b of fastening unit 44b, and/or fastening element 64b being connected with bearing element 26b via a not-shown bonded, non-positive, and/or form-fit connection. The distance between directly adjacent bearing elements 26b, 28b, 30b is equivalent to a diameter of damping elements 18b, 20b, thereby resulting in two separate tracks for guiding and/or supporting damping elements 18b, 20b.

Damping elements 18b, 20b are supported such that they may pivot around a pivot axis 22b that extends parallel to axial direction 36b, 38b of auxiliary handle 14c. In addition, damping elements 18b, 20b function as an unbalanced mass during operation of auxiliary handle device 10b in that a centrifugal force produces an uneven distribution of mass of damping elements 18b, 20b around pivot axis 22b. During operation of auxiliary handle device 10b, damping elements 18b, 20b are excited by an initial oscillation of a hand-held power tool 12b to oscillate around pivot axis 22a, the oscillation of damping elements 18b, 20b offsetting the initial oscillation. In order to dampen vibrations, spherical damping elements 18b, 20b are also designed to rotate on their own during operation of auxiliary handle device 10b, i.e., to rotate around a rotation axis that extends through a center point of damping elements 18b, 20b.

FIG. 4 shows an alternative auxiliary handle device 10c with a damping unit 16c that includes two annular damping elements 18c, 20c designed as absorber mass elements. Annular damping elements 18c, 20c are located around an end region 42c facing away from a fastening unit 44c. Annular damping elements 18c, 20c have different diameters, which are greater than a diameter of end region 42c. As a result, outwardly and in a radial direction 66c, end region 42c is located before damping element 18c with the smaller diameter, which, in turn, is located before damping element 20c with the larger diameter.

Damping unit 16c includes four cylindrical bearing elements 26c, 28c, 30c, 32c, which support the two annular damping elements 18c, 20c such that they may pivot around pivot axes 22c, 24c. Damping elements 18c, 20c are supported via bearing elements 26c, 28c, 30c, 32c in such a manner that they are movable relative to each other. Two of the bearing elements 26c, 28c are located on opposite sides of end region 42c in two cylindrical recesses 68c in end region 42c, and they extend radially outwardly from end region 42c. In addition, the two bearing elements 26c, 28c are located with an end that faces away from end region 42c in cylindrical recesses 70c in damping element 18c. As a result, damping element 18c is tiltable around pivot axis 22c, which is coaxial with the two bearing elements 26, 28c. The other two bearing elements 30c, 32c are similarly located between the two annular damping elements 18c, 20c, but offset by approximately 90°. As a result, pivot axes 22c, 24c of the two annual damping elements 18c, 20c are oriented perpendicularly to each other, and a tilting motion of the two damping elements 18c, 20c relative to each other is made possible, with the two damping elements 18c, 20c being gimbaled to auxiliary handle 14c.

During operation of auxiliary handle device 10c, annular damping elements 18c, 20c are excited via an initial oscillation of a hand-held power tool 12c to oscillate around pivot axes 22c, 24c, thereby offsetting the initial oscillation. In addition, auxiliary handle 14c and/or a grip sleeve 58c is designed longer by a length equivalent to a diameter of grip sleeve 58c, thereby ensuring that a grip region for an operator remains unrestricted.

It will be understood that each of the elements described above, or two or more together, may also find a useful application in other types of constructions differing from the type described above.

While the invention has been illustrated and described as embodied in an auxiliary handle device, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. An auxiliary handle device, comprising an auxiliary handle; a damping unit including at least one damping element, said damping element being configured to pivot about a pivot axis while vibrations are being damped.

2. An auxiliary handle device as defined in claim 1, wherein said damping unit includes at least one bearing element which is configured to support said damping element.

3. An auxiliary handle device as defined in claim 1, wherein said damping element is configured as an absorber mass element.

4. An auxiliary handle device as defined in claim 3, wherein said absorber mass element of said damping element is configured as an unbalanced mass.

5. An auxiliary handle device as defined in claim 1, wherein said damping unit includes at least one energy conversion element for converting vibrational energy into electrical energy.

6. An auxiliary handle device as defined in claim 5, wherein said damping element includes at least a portion of the energy conversion element.

7. An auxiliary handle device as defined in claim 1, wherein said auxiliary handle has at least one end region that extends in an axial direction of said auxiliary handle, said damping unit having at least a portion located on said at least one end region of said auxiliary handle.

8. An auxiliary handle device as defined in claim 1; and further comprising a fastening unit for attachment to the hand-held power tool, said damping unit having at least a portion which is located after said end region that faces said fastening unit, in a direction of said fastening unit.

9. An auxiliary handle device as defined in claim 1, wherein said damping unit includes at least two said damping elements which are movable relative to one another.

10. An auxiliary handle device as defined in claim 9, wherein said damping elements are located such that they are tiltable relative to each other.

11. A hand-held power tool, comprising a main handle; and an auxiliary handle device, said auxiliary handle device including an auxiliary handle, and a damping unit including at least one damping element, said damping element being configured to pivot about a pivot axis while vibrations are being damped.

12. A hand-held power tool as defined in claim 11, wherein the hand-held power tool is configured as an angle grinder.
